(19) United States
(12) Patent Application Publication
(10) Pub. No.: US 2020/0001904 A1
(43) Pub. Date: Jan. 2, 2020

(54) CONNECTING ELEMENT FOR ATTACHING A COMPONENT TO A FIBER COMPOSITE STRUCTRUE

(71) Applicants: CRRC QINGDAO SIFANG CO., LTD., Qingdao, Shandong (CN); CG RAIL - CHINESISCH-DEUTSCHES FORSCHUNGS- UND ENTWICKLUNGSZENTRUM FÜR BAHN- UND VERKEHRSTECHNIK DRE, Dresden (DE)

(72) Inventors: Yunshuang MA, Qingdao, Shandong (CN); Shuxiang CHEN, Qingdao, Shandong (CN); Yongfeng TAI, Qingdao, Shandong (CN); Jinghai JIAO, Qingdao, Shandong (CN); Zhengyu SONG, Qingdao, Shandong (CN); Jiajie HE, Qingdao, Shandong (CN); Werner HUFENBACH, Dresden (DE); Andreas ULBRICHT, Dresden (DE)

(73) Assignees: CRRC QINGDAO SIFANG CO., LTD., Qingdao, Shandong (CN); CG RAIL - CHINESISCH-DEUTSCHES FORSCHUNGS- UND ENTWICKLUNGSZENTRUM FÜR BAHN- UND VERKEHRSTECHNIK DRE, Dresden (DE)

(21) Appl. No.: 16/484,609

(22) PCT Filed: Feb. 8, 2018
(86) PCT No.: PCT/EP2018/053216

§ 371 Date: Aug. 8, 2019

(30) Foreign Application Priority Data
Feb. 9, 2017 (DE) 10 2017 102 562.6

(51) Int. Cl. B61D 17/04; B29C 65/56; B29C 65/00; F16B 19/02; F16B 35/04

(52) U.S. Cl. CPC B61D 17/043; B29C 65/562; B29C 66/742; B29L 2031/3064; F16B 19/02; F16B 35/048; B29C 66/721

(57) ABSTRACT

A connecting element for fastening connection pieces to fiber composite components made of at least one fiber layer and of matrix material is provided, the connecting element has a screw- or bolt-like shape, the connecting element includes a tip at one end thereof, which tip supports the penetration of the fiber layers of the fiber composite component in the dry or matrix-impregnated, unconsolidated state, and comprising a casing in the region that comes in contact with matrix material of the fiber composite component, but at least in the region that comes in contact with the reinforcing fibers of the fiber composite component.

### FIELD

The present invention relates to a connecting element with which a connecting component can be connected to a fibre composite structure, in particular a special ring beam structure made of fibre composite material. The ring beam is part of the construction of a head module (the cab) for a rail vehicle and is to contribute to the dissipation and distribution of the loads that occur in the event of a crash.

### BACKGROUND

In particular, the head module is a construction for commuter trains, in particular underground trains. In such trains, the head module is often integrated into the coach. The head module is also referred to as cab in the following.

In the interests of material and energy efficiency, in recent years the use of light materials and of the principles of lightweight construction has become increasingly established in rail vehicle construction. In particular the use of fibre composite materials is constantly increasing. This also applies to the design of the head modules of rail vehicles.

Known constructions here provide for attaching prefabricated modules to the substructure, which runs through the entire coach without interruption.

Thus DE 197 25 905 relates to a method for connecting a prefabricated head module made of fibre-reinforced plastic (FRP) to the underframe and the coach body module. The side walls of the head module are preferably manufactured as a sandwich structure made of FRP with a core material in between. Here, special reinforcing profiles are used in the joining areas of the head module, which improve the force transmission between underframe or coach module and the FRP walls of the head module. A special design of the fibre direction of the FRP reinforcement is not provided. The reinforcing profiles are integrated into the core of the FRP walls of the head module and act as support for the bolt connection between FRP walls of the head module and underframe or coach body module. A disadvantage here is that the reinforcing fibre material between the reinforcing profile and the underframe is subjected to a compressive load and there is thus the risk of damage, due to creep, to the FRP material in this area.

WO 2010/029188 A1 discloses a self-supporting vehicle head which is preferentially composed of fibre composite material. The vehicle head has structural elements which serve to absorb energy in the event of a crash as well as other structural elements which do not have a specific function for energy dissipation. In particular, the energy-absorbing structural elements are also to consist of fibre composite material. It is furthermore provided that a series of energy-dissipating structural elements successively contributes to the energy absorption or transmits corresponding forces. The vehicle head has a central buffer coupling which due to its design lies in front of the external cladding of the vehicle head. An energy absorption element that is to absorb impacts exerted thereon is therefore arranged directly behind the central buffer coupling. In addition, two lateral energy absorption elements are arranged parallel thereto, which are to act as anti-overriding protection. Furthermore, the railing underneath the front window has at least one, preferably two, energy absorption elements. On each side of the head section, two lines for energy transmission lead from the railing into the substructure of the coach section. In addition, two energy absorption elements are arranged in front of the two A pillars in the direction of movement. The published document contains no teaching on how the plurality of different elements are also to be connected to metallic components.

It is known from DE 37 15 409 A1, when metallic connecting elements are to be guided through fibre plies of fibre composite materials, to use an awl which, using its pointed shape, pushes through the fibres, whereupon the connecting elements (screws, bolts) can easily be guided through the now created openings. In this approach, the awl is designed as a separately formed tool, which makes it necessary to remove the awl after the initial displacement of the fibres. The fibres can thereby slip back to their old position, which can impede or even prevent the insertion of the connecting elements. This applies in particular to connecting elements with a relatively large cross section.

In DE 2015 106 563 A1, a method for connecting FRP structural components, in particular aircraft structural components, is disclosed. The structural components to be connected are heated for easier penetration of the matrix and then penetrated and connected by means of a fastening device. The fastening device has a head, a body and a tip which can be designed removable. Disadvantageously, the fastening devices have no means whatever which can prevent them from getting caught on fibres during penetration and thus causing damage.

The driver's cab is preferably formed as a two-shell construction. The outer shell is connected to the three systems which convert the impact energy into deformation in the event of a crash. The inner shell lines the actual interior space which can be used by people. Both shells are formed as fibre composite structures which do not make any significant contributions to the crash resistance. The outer shell guarantees the necessary stiffness of the construction in that it is realized as a multilayered fibre composite structure, optionally with cores lying between the fibre layers. Laid, twisted or braided fibre fabrics can be used in the fibre layers. To improve the stiffness, UD fibre strands (unidirectional fibre strands) are also possible. It is advantageous that the A pillars of the outer cab have no special reinforcements for the force transmission in the event of a crash. This prevents a disadvantageous force transmission onto the ring beam from occurring in the event of a crash or at least limits it. The A pillars of the outer cab are preferably designed for the feeding-through of electrical wires. The outer cab shell is preferably constructed from fibre non-crimp fabrics which are then impregnated with a matrix material and consolidated. The construction from fibre non-crimp fabrics pre-impregnated with matrix material is also possible. The outer shell is preferably connected to the inner shell in the area of the front window. Here the two shells are screwed, adhesively bonded or connected to each other in another way.

The ring beam is particularly important. The ring beam has a U shape in which the two ends of the ring beam are fixed to the upper longitudinal beams of the following coach section. The front surface of the ring beam (corresponds to the lower curvature of the U shape) is arranged on the inner surface of the upper front side of the outer cab shell. The ring beam is preferably designed as a fibre composite component. UD fibre plies which run over the entire length of the ring beam from one fixing point on an upper longitudinal beam of the following coach section to the other fixing point on the other upper longitudinal beam of the following coach section, are used for the ring beam here. These UD fibre plies can be used alternating with fibre plies which can have differing fibre orientations. Fibre plies made of woven fabrics are preferred. In particular, fibre plies with differing orientations or woven fabric or meshwork are used to hold the UD fibres in place before the consolidation. In particular, carbon-fibre composite materials are preferably used.

The connection of the ends of the ring beam to the upper longitudinal beams of the following coach section is preferably realized by connection pieces. These connection pieces support the connection to upper longitudinal beams of the following coach section in that, with sufficient strength, they provide the required openings for the installation (preferably screw connection). These openings are in particular one screw opening or several screw openings for each ring beam end with respect to corresponding openings in the upper longitudinal beams of the following coach section. In addition, optional openings are provided through which connecting bolts, or nuts, screws or similar can be inserted into the openings and optionally held up there in the case of screw connections.

Thus the connection pieces must be able to transmit large forces both during normal operation and in the event of a crash.

Conventional methods for connecting the connection pieces to the ring beam ends envisage that the already consolidated ring beam is provided with bores through which the bolts or screw connections which hold the connection pieces on the ends of the ring beam can then be fed. The disadvantage of this approach is that the fibre structure in the ring beam is damaged during boring. In addition, the metallic bolts or screws which are to hold the connection piece must be protected against direct contact with the open ends of the carbon-fibre reinforcing materials. Otherwise electrochemical corrosion could weaken or destroy the bolts or screws.

### SUMMARY

Thus the object in general is to propose connecting elements which facilitate the installation of components, preferably metallic components, on fibre composite components, in particular on carbon-fibre composite components. More specifically, the object is to propose connecting elements with which the connection pieces can be fixed on the ends of the ring beam, which avoid the named disadvantages. The connection pieces are preferably metallic, particularly preferably made of stainless steel or titanium. However, in principle, the proposed connecting elements can also be used for connecting components or connection pieces made of other materials.

The object is achieved according to the invention with a connecting element according to claim 1. Advantageous embodiments are disclosed in the subordinate dependent claims. A use of the connecting element according to the invention is disclosed in claim 9.

The ring beam is preferably manufactured together with the outer cab shell. A ring beam moulded part that already has the fibre-reinforcing structure of the ring beam is placed in the mould in which the outer cab shell is manufactured. The fibre plies of the ring beam and of the outer cab shell are then impregnated with matrix material together and this is then consolidated (the matrix material is cured). It is also possible to pre-impregnate the ring beam moulded part with matrix material and then place it in the mould or place it on a support construction on which the further fibre plies of the outer shell are then placed, likewise as pre-impregnated fibre plies (e.g. as pre-pregs). Here too this is then consolidated.

A further preferred embodiment provides for manufacturing the outer cab shell and the ring beam as separate components and introducing the consolidated ring beam into the consolidated outer cab shell and fixing it there, preferably gluing it in.

In yet a further preferred embodiment, the fibre-reinforcing structure of the ring beam is constructed in plies of fibre-reinforcing plies in the mould.

The ring beam consists of several plies of reinforcing fibres. Both plies of unidirectional fibres (UD plies) and braided or bidirectionally laid plies are used. The different plies advantageously alternate with each other. In particular it is advantageous to surround a core with UD fibres with a braided or twisted outer shell which determines the shape of the ring beam. Advantageously, non-crimp fabrics made of rovings or pre-pregs can also be used as outer shell. The individual plies of the ring beam are preferably connected to each other. This can be effected by sewing, knitting or clamping. The use of plastic connectors is also possible.

To avoid the disadvantageous boring through of the consolidated fibre composite material at the ends of the consolidated ring beam, the bolts or screws are positioned at the provided points, according to the device, or freely, in the dry or in the wet, unconsolidated state (impregnated with matrix material) of the matrix material and fed through the reinforcing fibre structure, wherein the fibres are displaced but not damaged.

In a first embodiment, the connection piece is designed in one part so that it completely surrounds the end of the ring beam and is held by bolts or screws which completely penetrate the ends of the ring beam.

In a further embodiment, the connection piece is designed in several parts, preferably two parts. Particularly preferred is a two-part design, in which the end of the ring beam is held between two half-shell-shaped parts, of the connection piece. Here, the two parts of the connection piece are arranged facing each other on one end of the ring beam.

In a third embodiment, the connection piece is designed in one part or in several parts, but is characterized in that it does not completely enclose the end of the ring beam. The bolts or connecting screws are supported in washers or shims on the surface of the ring beam material on one side and by the material of the connection piece on the other side.

In a first preferred procedure, it is envisaged to provide the reinforcing fibre material in the sought shape in the dry state or in the unconsolidated state impregnated with matrix material. This is effected in that the ring beam (as a series of plies) is placed in a mould and the connection pieces are placed on the ring beam and the metallic connecting elements according to the invention, such as bolts or screws, are then pushed through the reinforcing fibre plies. Alternatively, the connection pieces can first be placed in the mould and the unconsolidated ring beam then introduced. A further advantage is that the connecting elements and the joining partners are arranged in the same mould. This advantageously prevents local tilting, and the laminate is protected against destruction by local bearing stress caused by displacement. In order to ensure both an absolute and relative positioning, the connecting elements can optionally be prepositioned on a support plate. Advantageously there is no damage to the fibres when the fibre plies are penetrated. The reinforcing fibre material of the outer housing shell can then be deposited on the ring beam and a joint impregnation with matrix material effected or, if all fibre materials are pre-impregnated, the consolidation effected. Advantageously, the metallic connecting elements are thus incorporated into the matrix and no gap forms, as is to be expected with boring according to previous methods. No corrosive media can therefore enter into such a gap. After the consolidation, the ring beam is connected by material bonding to the outer housing shell, exclusively via the matrix material. Finally, outer housing shell and ring beam can be removed from the mould in one piece.

In a second preferred procedure, the reinforcing fibre material of the ring beam is prepared in a separate mould in the dry state or in the unconsolidated state impregnated with matrix material. The bolts or screws according to the invention are then pushed through the reinforcing fibre plies and the connection pieces installed. Advantageously this is also effected without damaging the fibres of the reinforcing fibre material. The reinforcing fibre material, if it has been prepared in the dry state, can then be impregnated with matrix material. In both cases (reinforcing fibre material prepared dry or impregnated) the prepared ring beam can then be removed and placed in the mould for the production of the outer shell. Further processing is then effected as in the first preferred procedure.

A third preferred procedure provides for an approach in accordance with the second preferred procedure, but with partial consolidation of the impregnated reinforcing fibre material after fitting of the connection pieces, and only then the transfer into the mould for the production of the outer shell.

The connecting elements according to the invention (e.g. as bolts or screws) can be prepared as individual components or fixed (e.g. welded or glued) to a part of the connection piece. They preferably consist of metallic materials, particularly preferably of steel. For tasks with different requirements in respect of strength and corrosion resistance, however, the connecting elements can also consist of other materials, e.g. plastic, FRP, ceramic etc.

In the course of a preferred variant of the method, the connecting elements are fed through the openings of the connection pieces provided for this purpose and the fibre plies. After the consolidation of the ring beam, shims (washers), or a further section of the connection pieces, are preferably deposited on the respective consolidated end of the ring beam and fixed there. This is effected e.g. by screwing or riveting the ends of the connecting elements. In each embodiment, the connecting elements completely penetrate the ring beam.

As individual components, the connecting elements have a head and a rod-shaped, elongated body which has a smaller cross section than the head. Preferably, the connecting elements have a rotation symmetry about the longitudinal axis of the body. This applies at least to the body itself which preferably has a circular cross section. Thus they correspond in their outer shape to conventional bolts or screws. In a further embodiment, the connecting elements have a rhomboid cross section the largest dimension of which lies in loading direction. This advantageously avoids a marked fibre direction change, and the associated pull stresses on the sides of the connecting element (through the orientation of the fibres under load) is reduced, as the hole is filled by the connecting element in load-dependent manner.

Arranged at the end of the connecting element according to the invention which is facing away from the head is a tip which supports the penetration of the fibre plies of the fibre composite component in the dry state or unconsolidated state impregnated with matrix. The metallic connection piece has openings for feeding through the body of the connecting element or is itself the head of one or more connecting elements. In the area which comes into contact with the matrix material of the fibre composite component, but at least in the area which comes into contact with the reinforcing fibres of the fibre composite component, the connecting element according to the invention has a casing.

The connecting elements (screws, bolts) are preferably themselves formed as awls and therefore need not be removed after successful penetration of the fibre plies. In a first simple embodiment, the connecting elements are designed pointed on the side which penetrates the fibre plies.

A second advanced embodiment provides that the pointed design of the connecting elements is realized by a removable tip. The removable tip can either be screwed onto an external thread section at the end of the connecting element with which the fibre plies are penetrated or the removable tip is inserted or screwed into an axial opening at the end of the connecting element with which the fibre plies are penetrated. If the tip is merely inserted into the axial opening, it can be held in position by a magnetic connection, a snap ring or similar.

An advantageous development provides that the tip, if there is a screw connection to the connecting element, is flattened on at least two opposite sides in order to enable a spanner, preferably an open-end spanner, to be applied for installation or deinstallation. The transition from the flat area to the rest of the removable tip in the direction of the connecting element is preferably designed round so that the fibres can also slide in this area upon penetration of the plies.

In a preferred approach, the thread turns of screws are to be protected, i.e. the thread turns are to be prevented from filling with resin. For this, both the thread turns and the casings forming the awl are provided with suitable release agents.

During penetration of the fibre plies, the surface of the connecting element is preferably coated with a friction-reducing agent.

When they penetrate the fibre plies, in particular in the case of carbon fibres, the connecting elements are preferably provided with a surface coating which prevents or at least greatly reduces a direct, electrically conductive contact between the material of the connecting elements and the carbon fibres. The friction-reducing agent and the surface coating can be identical if the chosen material has the necessary properties. Such materials are known from the state of the art.

Connecting elements can disadvantageously get caught on fibres during penetration and cause them to break, in particular when they are provided with an external thread. Advantageously, the connecting elements therefore have a casing. This is preferably designed as a type of tube, with smooth external walls, fitted tightly at least to the body of the connecting elements. In the case of connecting element bodies provided with an external thread, this casing can also be screwed on. In a preferred procedure, this casing is pulled off or unscrewed and removed after the fibre plies have been penetrated so that it does not remain in the ring beam. A further preferred embodiment provides that the casing remains in the ring beam and is co-embedded into the matrix in the course of impregnation with matrix material and subsequent consolidation.

In a preferred embodiment, the casing is not screwed onto the body of the connecting element, but implemented over the whole length of the connecting element in contact with the fibre composite material. Thus it is advantageously possible to pull the remaining parts of the connecting element out of the casing and to enable the connecting element to be replaced or the connection piece held by the connecting element to be exchanged.

The casing can also advantageously be used to prevent electrically conductive contact between the metallic material of constituents of the connecting element and the carbon fibre reinforcement. Here, the casing covers at least the part of the connecting element which comes into contact with the reinforcing fibre material, optionally the whole section of the connecting element coming into contact with matrix material.

The tip preferably projects in its circumferential direction beyond the cross section of the connecting element body to the extent that it forms a continuous section with the casing. This prevents fibres from getting caught on the edge of the casing.

The casing preferably consists of a plastic material, particularly preferably of the same material which is used as matrix material. However it is also possible to use a suitable thermoplastic or another plastic which is not chemically affected by the matrix material.

A coating of matrix material on the connecting elements is also possible. This is then restricted to the section of the connecting element which runs inside the ring beam in the installed state.

An advantageous development of the casing provides that the latter is perforated in order to make it possible for the matrix material to penetrate directly as far as the connecting element body. These perforations are preferably designed [as] elongated openings running axially parallel to the body of the connecting element, preferably over almost the whole length of the casing or also as circular or ellipsoidal (preferably semi-major axis of the ellipse parallel to the longitudinal axis of the connecting element). However, edges on which the fibres of the fibre-reinforcing material could catch are preferably to be avoided (or rounded). Matrix material can penetrate through the openings, but the fibres of the reinforcing material, due to their bending radii, bridge these openings without making contact with the body of the connecting element.

In a further advantageous development, the casings forming the awl themselves form functional components that can be used later within the meaning of an embedded internal thread.

After the connecting elements are introduced and the matrix material of the ring beam is consolidated (this is optionally effected together with the consolidation of the outer shell), the connecting elements are fixed. This is preferably effected in that a nut is screwed onto the side opposite the head of the connecting elements, or the protruding end is riveted.

Even if the connecting elements according to the invention have been developed for use on carbon-fibre composite materials, the use with other fibre composite materials, in particular plastics reinforced with glass fibres, is readily possible. A use for connecting components made of different materials (e.g. glass, wood, metal, fibre composite materials, plastics without fibre reinforcement, ceramic or mineral substances etc.) to components made of fibre composite material is advantageously possible.

### BRIEF DESCRIPTION OF THE DRAWINGS

The following figures illustrate the connecting elements according to the invention in their preferred use for connecting connection pieces to a ring beam for head modules of rail vehicles by way of example.

### DETAILED DESCRIPTION

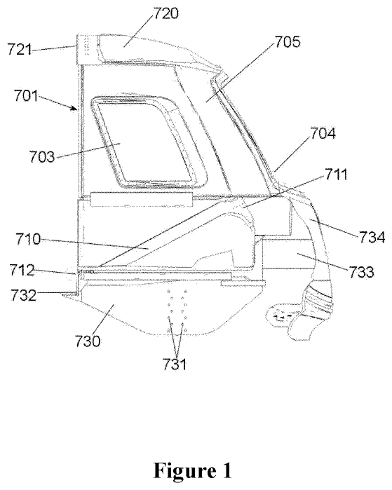

FIG. 1 shows a schematic side view of the cab without the outer shell. The central buffer coupling has also been omitted for the sake of clarity. The inner shell 701 is designed in two parts. The division occurs in the horizontal plane above the railing reinforcement 711. The upper part of the inner shell 701 comprises the opening 704 for the front window and the side windows 703. The window openings are separated from each other by the A pillar 705. Above the upper part of the inner shell the ring beam 720 is represented. It is detachably fixed to the upper longitudinal beams of the following coach section (not represented) via the connection piece 721.

The railing reinforcement 711 and the UD braces 710 which transmit the force from the railing reinforcement 711 to the introduction points 712 into the lower longitudinal beams of the following coach section are integrated into the lower part of the inner shell.

The lower crash conduction element 730 runs underneath the lower part of the inner shell. On the front side of the cab the plate 734 is represented. The crash box 733 is arranged behind it. In the event of a crash, the collision takes place on the plate 734 which passes the force onto the crash box 733 and dissipates it as far as possible there. Remaining impact energy is passed on into the lower crash conduction element 730 and there is transferred at the fixing point 732 into the underframe support of the following coach section. In the horizontal section of the lower crash conduction element 730, the openings 731 for fixing the central buffer coupling are visible.

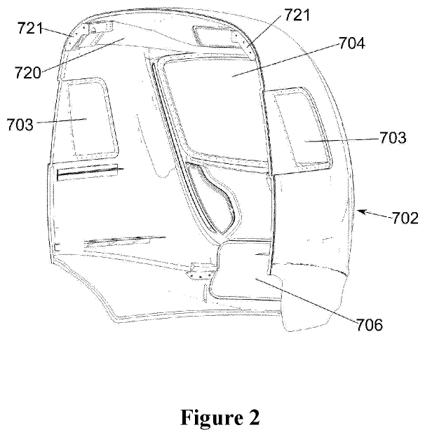

FIG. 2 shows a schematic three-dimensional view of the outer shell 702. In particular, it can be seen how the upper ring beam 720 with its connection pieces 721 fits into the outer shell 702. The opening for the cover flap 706 of the central buffer coupling is also represented.

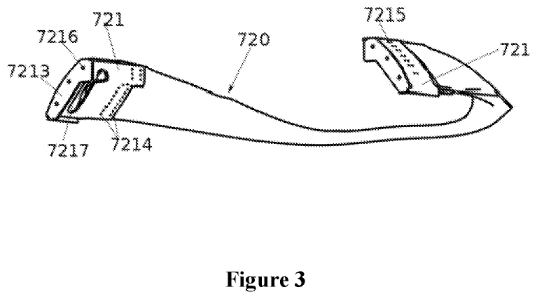

FIG. 3 shows, schematically, the structure of the ring beam 720 with the two connection pieces 721. The connection pieces 721 are connected to the ring beam via connecting elements (not represented) through the openings 7214. They have the installation openings 7217 through which the ring beam is connected to the following coach section via the connection pieces 721 and the front section 7213. For this, connecting elements (not represented), in particular screws, are fed through the openings 7216, which can be tightened through the installation opening 7217. The openings 7215 optionally allow a screw connection to the outer shell.

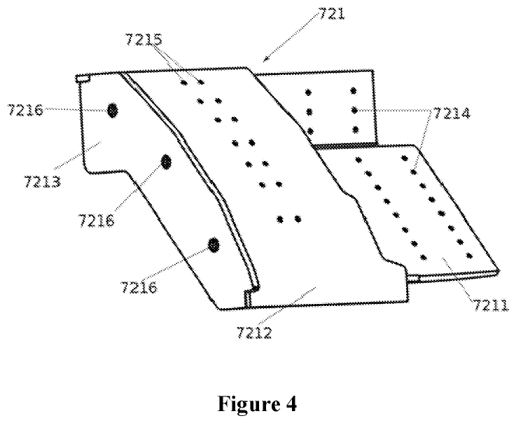

FIG. 4 shows, schematically, an embodiment of the connection piece 721. This connection piece has a lower section 7211, an upper section 7212 and the front section 7213. The sections consist of steel and are fixed to one another by means of welded joints.

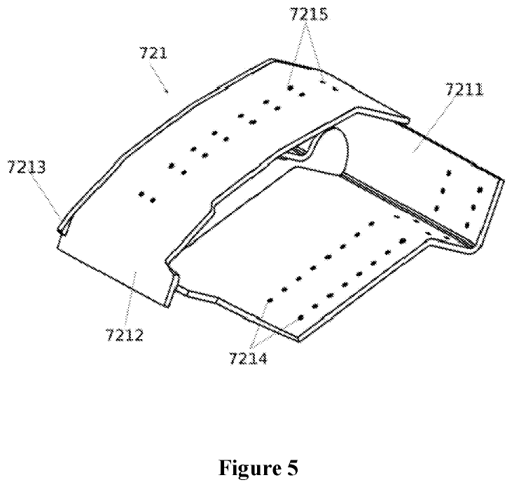

FIG. 5 shows, schematically, the connection piece according to FIG. 4 from a different perspective.

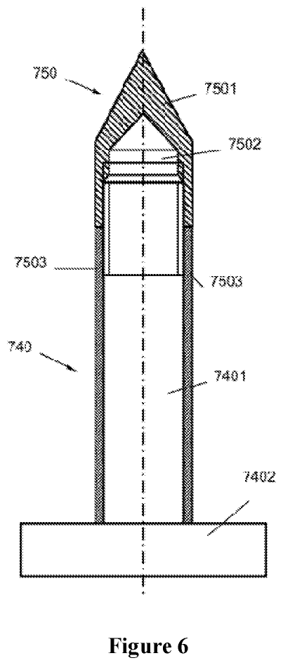

FIG. 6 shows, schematically, an embodiment for a connecting element 740 in section along the longitudinal axis. The connecting element has the shape of a screw and consists of a head section 7402 and a body 7401. It has no thread in the section which comes into contact with the matrix material after installation. The casing 7503, which prevents direct contact between the metallic constituents of the connecting element and the reinforcing fibre structure, is arranged there. The casing 7503 remains in the fully consolidated and installed ring beam. The tip 751 has a pointed section 7501 which is screwed onto the thread 7502. After the fibre composite material is consolidated, the tip is unscrewed and the nut for fixing the connecting element is screwed onto the thread 7502, and a washer or a further section of the connection piece optionally placed underneath.

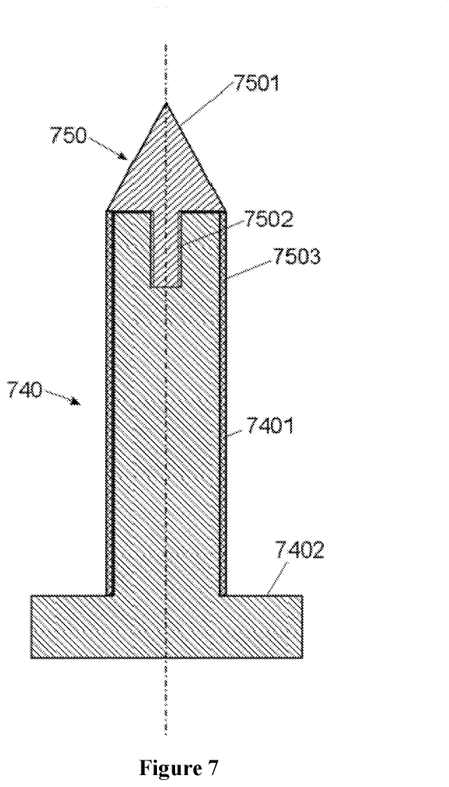

FIG. 7 shows, schematically, an alternative embodiment to FIG. 6. Here, the tip 750 is held on the upper end of the bolt 740 by means of an internal thread 7502.

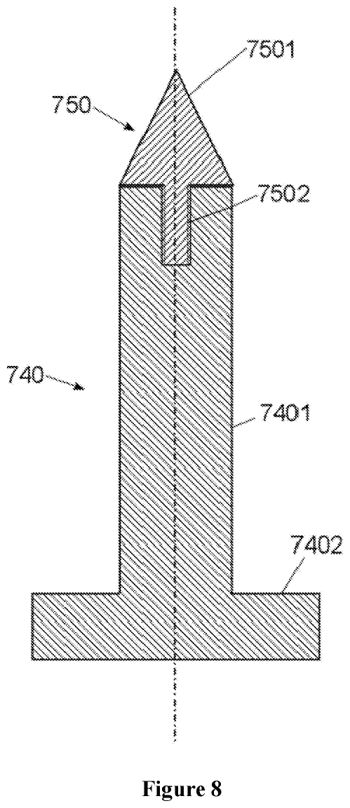

FIG. 8 shows the embodiment according to FIG. 7, but without additional casing.

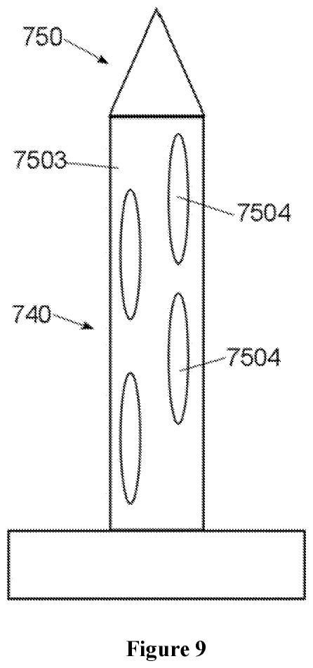

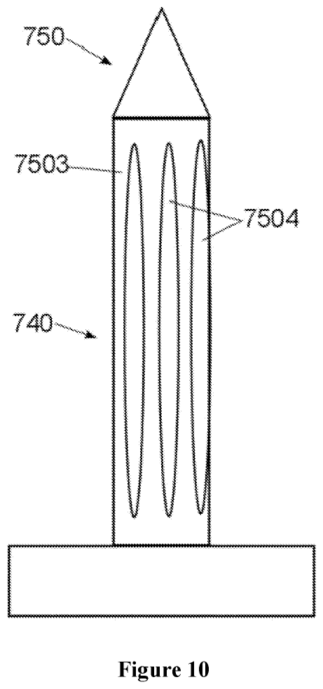

FIG. 9 and FIG. 10 show, schematically, two variants of perforations 7504 in the casing 7503.

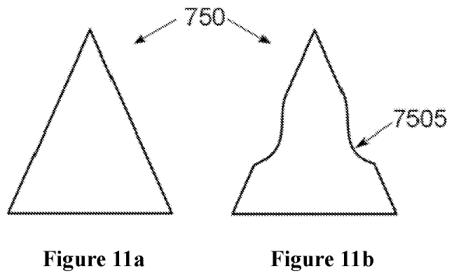

FIG. 11a and FIG. 11b show, schematically, a tip in front view (FIG. 11a) and after a rotation by 90° about the longitudinal axis (FIG. 11b). Thus the lateral flat area 7505, which allows a spanner to be applied for installation or deinstallation of the tip 750 on the connecting element, is visible.

### LIST OF REFERENCE NUMBERS

701 inner shell

702 outer shell

703 side window opening

704 front window opening

705 A pillar

706 cover flap of the central buffer coupling

707 internal fittings

710 UD brace of the railing reinforcement

711 railing reinforcement

712 introduction point of the forces from the railing reinforcement into the lower longitudinal beam of the following coach

720 ring beam

721 connection piece

7211 lower section

7212 upper section

7213 front section

7214 openings

7215 openings

7216 openings

7217 installation openings

730 lower crash conduction element

7301 section of the crash conduction element from the crash box to the horizontal section

7302 horizontal section

7303 section of the crash conduction element from the horizontal section to the fixing element on the underframe support

731 holes for fixing the central buffer coupling

732 fixing device of the lower crash element on the underframe support

733 crash box

734 plate

740 connecting bolts for fixing the connection piece to the ring beam

7401 bolt body

7402 bolt head

750 tip for supporting the penetration of the fibre-reinforcing material

7501 pointed section

7502 thread

7503 casing of the connecting bolt

7504 perforations in the casing of the connecting bolt

7505 flat area of the tip

1. Connecting element for fixing connection pieces to fibre composite components made of at least one fibre ply and matrix material, comprising a screw- or bolt-like shape with a head and a body, wherein the body has an elongated shape with a smaller cross section than the head, and wherein at the end which is facing away from the head a tip is arranged, which supports the penetration of the fibre plies of the fibre composite component in the dry state or unconsolidated state impregnated with matrix, wherein the metallic connection piece has openings for feeding through the body of the connecting element or is itself the head of one or more connecting elements, wherein the connecting element has a casing in the area which comes into contact with the matrix material of the fibre composite component, but at least in the area which comes into contact with the reinforcing fibres of the fibre composite component.

2. Connecting element according to claim 1, wherein the tip is removable.

3. Connecting element according to claim 2, wherein the tip is screwed onto an external thread of the connecting element.

4. Connecting element according to claim 2, wherein the tip is screwed onto an internal thread of the connecting element which is arranged axially at the end of the connecting element.

5. Connecting element according to claim 2, wherein the tip is inserted into an opening of the connecting element which is arranged axially at the end of the connecting element.

6. Connecting element according to claim 1, wherein the tip has flat areas which facilitate the application of a spanner for installation or deinstallation of the tip on the connecting element.

7. Connecting element according to claim 1, wherein the casing is removed from the fibre composite component after penetration of the fibre plies and before consolidation, or in that the casing remains in the fibre composite component.

8. Connecting element according to claim 1, wherein the casing has perforations which allow matrix material to enter as far as the surface of the connecting element.

9. Connecting element according to claim 8, wherein the width of the perforations perpendicular to the longitudinal axis of the connecting element is so small that the reinforcing fibres bridge the perforations and, due to their bending radius, do not reach the material surface of the connecting element.

10. Use of a connecting element according to claim 1 for fixing a metallic connection piece to a ring beam made of fibre composite material for a head module of a rail vehicle, wherein, during the production of the ring beam, the connecting element is fed through openings of the connection piece provided for this and through the dry fibre plies or unconsolidated fibre plies, impregnated with matrix, of the ring beam.

11. Use of a connecting element according to claim 1 for fixing a metallic connection piece to a ring beam made of fibre composite material for a head module of a rail vehicle, wherein at least one connecting element is arranged on the connection piece, and is fed through the dry fibre plies or unconsolidated fibre plies, impregnated with matrix, of the ring beam, and fixed on the side of the ring beam opposite the connection piece.

12. Use of a connecting element according to claim 1 for fixing a component made of glass, wood, metal, fibre composite materials, plastics without fibre reinforcement, ceramic or mineral substances to a component made of fibre composite material.

13. Connecting element according to claim 2, wherein the tip has flat areas which facilitate the application of a spanner for installation or deinstallation of the tip on the connecting element.

14. Connecting element according to claim 3, wherein the tip has flat areas which facilitate the application of a spanner for installation or deinstallation of the tip on the connecting element.

15. Connecting element according to claim 4, wherein the tip has flat areas which facilitate the application of a spanner for installation or deinstallation of the tip on the connecting element.

16. Connecting element according to claim 5, wherein the tip has flat areas which facilitate the application of a spanner for installation or deinstallation of the tip on the connecting element.

17. Connecting element according to claim 2, wherein the casing is removed from the fibre composite component after penetration of the fibre plies and before consolidation, or in that the casing remains in the fibre composite component.
